(19) United States
(12) Patent Application Publication
(10) Pub. No.: US 2004/0075077 A1
(43) Pub. Date: Apr. 22, 2004

(54) Method for cooling high temperature engines

(76) Inventor: Jean-Pierre Maes, Merelbeke (BE)

Correspondence Address: Steven R. Ellinwood, ChevronTexaco Corporation, P. O. Box 6006, San Ramon, CA, 94583-0806, US

(21) Appl. No.: 10/277,346

(22) Filed: Oct. 21, 2002

(51) Int. Cl. C09K 5/00

(52) U.S. Cl. 252/71

(57) ABSTRACT

The present invention is directed to a method of cooling an internal combustion engine comprising circulating in the cooling system of an engine, operating at a temperature of at least 140° C., an effective amount of an engine coolant comprising a liquid alcohol freezing point depressant, a C₅ to C₁₆ carboxylic acid or salts thereof. In preferred embodiments; oxidation of liquid alcohol based freezing point depressants in high temperature applications is suppressed by use of one or more aliphatic monocarboxylic acids or the alkali metal, ammonium or amine salts thereof in combination with dicarboxylic acids or alkali metal, ammonium or amine salts thereof and triazoles and/or, optionally, imidazoles.

### BACKGROUND OF THE INVENTION

1. Field of the Invention

This invention relates to a method of cooling liquid cooled internal combustion engines operating at high temperatures. I have found that coolant containing glycol based freezing point depressants, carboxylate corrosion inhibitors, triazole and, optionally, imidazole or derivatives thereof is not as susceptible as conventional coolant to glycol degradation at high temperatures.

2. Background of the Invention

To comply with increasingly stringent air pollution control and fuel efficiency regulations as well as market forces, automotive and heavy-duty engine manufacturers are seeking new technology to reduce engine fuel consumption and exhaust emissions. It is well known that contemporary engines typically operate at less than optimum temperature conditions, which increases fuel consumption and exhaust gas emissions. In fact, it is estimated that in automotive applications engines operate at less than optimum conditions about 95% of the running time. Accordingly, engine manufactures are developing methods and systems to stabilize and improve engine operating conditions, including engine thermal management systems that will enable engine operation at much higher and stable temperatures.

Prior art automotive and heavy-duty engine coolants are designed for use at temperatures typically ranging from about 80-105° C., while heat rejecting surfaces that emanate heat and need to be cooled, such as the engine block, turbo chargers, exhaust gas coolers and fuel injectors, can develop coolant contact surface temperatures ranging from about 110° C. to about 135° C. Even in contemporary engine cooling systems such high temperatures result in nucleate boiling at the coolant/contact surface interface giving rise to coolant temperatures at or near the boiling point under cooling system pressures. As the engine efficiency trend continues it is anticipated that coolant temperatures will increase to temperatures greater that 110° C. and that the temperature of the heat rejecting surfaces will be on the order of about 230° C. to about 320° C.

A recent example, one such thermal management technology is a method known as cooled exhaust gas recycle (“EGR”), which reduces exhaust emissions. U.S. Pat. No. 6,244,256 discloses a two stage EGR system with a secondary cooling loop where; “a high temperature coolant flows through a high-temperature exhaust gas cooler [and a] large amount of heat is transferred from the very hot exhaust gases to the coolant.” In this system exhaust gas temperatures are in the range of 450° C. to 700° C. and the coolant in the secondary cooling loop reaches temperatures as high as 130° C. upon exposure to these exhaust gases. Similarly, U.S. Pat. No. 6,374,780 (Visteon Global Technologies) describes a method and apparatus to control engine temperature in a closed circuit cooling system of an automobile as a function of fuel economy, emissions, thermal and electrical load management and WO 02/23022 (Volkswagen AG) describes a method for regulating coolant temperature for an internal combustion engine according to load and rotational speed.

In addition to the above patent developments, publicized research results show that a coolant temperature of about 140° C. results in a fuel saving of 4%. Also carbon oxide (COx) and hydrocarbon (HC) exhaust emissions can be reduced, respectively, about 5% and 15% (Auto & Motor Techniek, 61, 2001, p. 20-23). And while, generally, higher combustion temperatures tend to increase the emission of nitrogen oxide (NOx), EGR methods reduce the oxygen content of the combustion gas, the combustion temperature and, thus the NOx emissions as well.

Clearly, the heat exchanger elements in an EGR system must be capable of meeting high demands in terms of compact design, efficient performance, and resistance to high temperatures, corrosion and fouling. However, at higher temperatures alcohol based freezing point depressants used in conventional engine coolants, such as ethylene glycol and propylene glycol, are more susceptible to oxidative degradation which results in corrosion and fouling of cooling systems. High temperatures cause formation of acidic decomposition products such as glycolates, oxalates and formates that lower the pH and render the coolant solutions more corrosive. It is also known that glycol degradation reactions are catalyzed by the presence of metals.

In the prior art, various carboxylate corrosion inhibitors have been added to glycol-based coolants and heat-transfer fluids to reduce corrosion of metallic systems. For example, various U.S. Patents describe carboxylate corrosion inhibitors combinations. U.S. Pat. No. 4,587,028 discloses non-silicate antifreeze formulations containing alkali metal salts of benzoic acid, dicarboxylic acid and nitrate. U.S. Pat. No. 4,647,392 discloses a corrosion inhibitor comprising the combination of an aliphatic monoacid or salt, a dicarboxylic acid or salt and a hydrocarbonyl triazole. U.S. Pat. No. 4,851,151 discloses a corrosion inhibitor using an alkylbenzoic acid or salt, an aliphatic monoacid or salt and a hydrocarbonyl triazole. U.S. Pat. No. 4,759,864 discloses phosphate and nitrite-free antifreeze formulations containing monocarboxylic acids or salts, an alkali metal borate compound and a hydrocarbyl triazole. U.S. Pat. No. 5,366,651 discloses antifreeze compositions containing an aliphatic monoacid or salt, a hydrocarbonyl triazole and imidazole.

All of the above described coolant/antifreeze compositions are used in contemporary automotive and heavy-duty engine cooling systems and are commonly subject to engine operating temperatures in the range of 80° C. to 105° C. None of the above described coolant compositions, nor any other contemporary coolant compositions are currently used in high temperature engine applications.

### SUMMARY OF THE INVENTION

I have discovered that, upon prolonged exposure to high temperatures, glycol based coolant/antifreeze formulations containing combinations and/or mixtures of one or more C₅-C₁₆ carboxylic acids or salts thereof resist oxidation of glycol more effectively than glycol based coolants containing conventional corrosion inhibitors such as alkali metal phosphate, nitrate, nitrite, borate, benzoate and silicate. I have also discovered that the anticorrosion properties of such coolant compositions are not significantly reduced under high temperature conditions.

Accordingly, at least one object of this invention is to provide a method for cooling internal combustion engines operating at temperatures at or above of 140° C. Such engines typically employ thermal management systems, exhaust gas cooling and/or exhaust gas recycle systems comprising primary and/or secondary cooling systems wherein coolant is circulated and exposed to very high temperatures. Under such conditions it will be desirable to use a coolant product that is resistant to glycol oxidation and minimizes corrosion of cooling system components. Thus, the present invention is directed to a method of cooling an internal combustion engine comprising circulating in a cooling system of an engine, operating at a temperature of a least 140° C., an effective amount of an engine coolant having a liquid alcohol freezing point depressant, and a C₅ to C₁₆ carboxylic acid or a salt of said acid. Particularly preferred embodiments of this invention include the use of engine coolant formulations comprising a liquid alcohol freezing point depressant and at least one aliphatic C₅-C₁₆ monocarboxylic acid or the alkali metal, ammonium or amine salt thereof, separately or in combination with one or more aliphatic C₅-C₁₆ dicarboxylic acids or the alkali metal, ammonium or amine salt of said acids. Optionally, a triazole, thiazole or an imidazole can be added.

### DETAILED DESCRIPTION OF THE INVENTION

The coolant formulation for use in the cooling systems of internal combustion engines operating at high temperature in accordance with the instant invention comprises a liquid alcohol freezing point depressant in combination with a carboxylic acid or a salt of said acid. In a preferred embodiment of the present invention an internal combustion engine operating at high temperature is cooled by circulating in the cooling system thereof a coolant formulation comprising a liquid alcohol freezing point depressant, in combination with one or more of a monocarboxylic acid or the alkali metal, ammonium, or amine salt of said acid, a dicarboxylic acid or the alkali metal, ammonium, or amine salt of said acid. More preferably, the monocarboxylic and dicarboxylic acids or salts thereof are aliphatic. Most preferably the coolant formulation for use in the cooling systems of internal combustion engines operating at high temperature in accordance with the instant invention comprises a liquid alcohol freezing point depressant in combination with at least one aliphatic monocarboxylic acid or the alkali metal, ammonium, or amine salt of said acid, with one or more aliphatic dicarboxylic or alkylbenzoic acids or the alkali metal, ammonium, or amine salt of said acids. Other preferred embodiments include the addition of a triazole or a thiazole and, optionally, an imidazole for use as corrosion inhibitors in aqueous systems, particularly in automobile and heavy duty engine antifreeze/coolant compositions.

The aliphatic monocarboxylic acid component of the above-described coolant formulation may be any aliphatic C₅-C₁₆ monocarboxylic acid or the alkali metal, ammonium, or amine salt of said acid, preferably at least one C₇-C₁₂ monocarboxylic acid or the alkali metal, ammonium, or amine salt of said acid. This would include one or more of the following acids or isomers thereof: heptanoic, octanoic, nonanoic, decanoic, undecanoic and dodecanoic, and mixtures thereof. Octanoic acid is particularly preferred. Any alkali metal, ammonium, or amine can be used to form the monobasic acid salt; however, alkali metals are preferred. Sodium and potassium are the preferred alkali metals for use in forming the monobasic acid salt.

The dicarboxylic acid component of the coolant formulation may be any hydrocarbyl C₅-C₁₆ dibasic acid or the alkali metal, ammonium, or amine salt of said acid, preferably at least one C₈-C₁₂ dicarboxylic acid or the alkali metal, ammonium, or amine salt of said acid. Included within this group are both aromatic and aliphatic C₅-C₁₆ dibasic acids and salts, preferably C₈-C₁₂ aliphatic dibasic acids and the alkali metal, ammonium, or amine salts of said acids. This would include one or more of the following acids: suberic, azelaic, sebacic, undecanedioic, dodecanedioic, the diacid of dicyclopentadiene (hereinafter referred to as DCPDDA), terephthalic, and mixtures thereof. Sebacic acid is particularly preferred. Any alkali metal, ammonium, or amine can be used to form the dibasic acid salt; however, alkali metals are preferred. Sodium and potassium are the preferred alkali metals for use in forming the dibasic acid salt.

The triazole component of the above-described corrosion inhibitor is preferably hydrocarbyl triazole, more preferably an aromatic or an alkyl-substituted aromatic triazole; for example, benzotriazole or tolyltriazole. The most preferred triazole for use is tolyltriazole. The hydrocarbyl triazole may be employed at concentrations of about 0.0001-0.5 wt. %, preferably about 0.0001-0.3 wt. %.

Imidazole may, optionally, be added at levels of from 0.0005 to 5 weight percent, preferably from 0.001 to 1 weight percent, the weight percent being based on the amount of liquid alcohol present. Alkyl- or aryl-substituted imidazoles may also be used.

The above-described coolant formulation mixture will most typically be employed in antifreeze formulations as coolants for internal combustion engines designed for operation at temperatures in excess of 140° C., such as automotive and heavy duty engines utilizing exhaust gas recycle and/or exhaust cooling technology. Other applications may include industrial heat transfer fluid applications requiring freezing protection at temperatures in excess of 140° C. In these applications, the monobasic and dibasic acid salts may be formed with metal hydroxides including sodium, potassium, lithium, barium, calcium, and magnesium.

The coolant/antifreeze formulations most commonly used include mixtures of water and water soluble liquid alcohol freezing point depressants such as glycol and glycol ethers. The glycol ethers which can be employed as major components in the present composition include glycols such as ethylene glycol, diethylene glycol, propylene glycol, and dipropylene glycol, and glycol monoethers such as the methyl, ethyl, propyl and butyl ethers of ethylene glycol, diethylene glycol, propylene glycol, and dipropylene glycol. Ethylene glycol is particularly preferred as the major coolant/antifreeze formulation component.

In one preferred method for cooling an internal combustion engine operating at high temperature, the above-described coolant formulation is employed in admixture with an aqueous antifreeze/coolant solution comprising 10% to 90% by weight of water, preferably 25% to 50% by weight, a water soluble liquid alcohol freezing point depressant, preferably ethylene glycol, and at least one alkali metal hydroxide which is employed to adjust the pH of the composition to a range from about 6.5 to 9.5, preferably from about 7.0 to 9.0.

The approximate proportions of the inhibitor components of the above-described coolant formulation (based upon the water soluble liquid alcohol freezing point depressant present) are: about 0.001 to 15.0 wt. %, preferably about 0.01 to 3.5 wt. % monocarboxylic acid or salt (calculated as the free acid); and about 0.001 to 15.0 wt. %, preferably about 0.01 to 3.5 wt. % dicarboxylic acid (calculated as the free acid).

One or more additional conventional corrosion inhibitors may also be employed in combination with the above-described corrosion inhibitor. Such conventional corrosion inhibitors may be employed at concentrations of 0.001-5.0 wt. %, and may be selected from the group comprising: alkali metal borates, alkali metal silicates, alkali metal benzoates, alkali metal nitrates, alkali metal nitrites, alkali metal molybdates, and hydrocarbyl triazoles and/or thiazoles. The most preferred conventional corrosion inhibitors for use in combination with the novel corrosion inhibitors of the instant invention are hydrocarbyl triazoles, hydrocarbyl thiazoles, and sodium metasilicate pentahydrate. Organosilane or other silicate stabilizers may also be employed in conjunction with the sodium metasilicate pentahydrate.

It has been found that excellent pH control and buffer capacity near neutral pH is provided when using combinations of partly neutralized aliphatic acid corrosion inhibitors and imidazole. Reserve alkalinity, reserve acidity and pH are easily controlled by either modifying the amount of neutralization of the acids and/or the imidazole content. The addition of imidazole assists in the pH control. Alkali metal hydroxides may be added to adjust the pH of the composition to the desired level. The formulations according to the present invention are simple to blend to a near neutral pH range, as is required in engine coolant/antifreeze systems.

The method of this invention will be further illustrated by the following examples, which are not intended to limit the invention, but to illuminate it. In the following examples, all percents are weight percents unless otherwise specified.

### EXAMPLES

To evaluate the high temperature oxidation resistance of liquid alcohol freezing point depressants, such as glycol and glycol ethers in engine coolants, the desired coolant formulations were heated to a high temperature (185° C. fluid temperature) in a pressure resisting stainless steel container. In this method, heat is transmitted into the test chamber through a coupon made of a typical metal found in internal combustion engine cooling systems, such as cast iron or cast aluminum. A means of sampling the test coolant during the course of the test is provided.

The following examples illustrate the performance of the C₅-C₁₆ carboxylate corrosion inhibitor combinations of this invention in moderating high temperature oxidation reactions and neutralizing the negative effects of the oxidation reactions, such as pH reduction and reserve alkalinity of the coolant solution.

### Example 1

A coolant concentrate containing a major amount of ethylene glycol, a combination of carboxylate corrosion inhibitors comprising 3.25% of 2-ethyl hexanoic acid and 0.25% sebacic acid, 0.04% of imidazole, 0.2% of tolyltriazole and sufficient NaOH to neutralize the formulation at a pH between 7.0 and 9.0.

### Example 2

A coolant concentrate containing a major amount of ethylene glycol, a combination of carboxylate corrosion inhibitors comprising 3.25% of 2-ethyl hexanoic acid and 0.25% sebacic acid, 0.2% of tolyltriazole and sufficient NaOH to neutralize the formulation at a pH between 7.0 and 9.0.

### Comparative Example A

A commercial coolant concentrate containing a major amount of ethylene glycol, a combination of conventional inhibitors comprising phosphate, borate, nitrate, tolyltriazole and silicate.

The concentrated coolant fluids were diluted with water to 33-vol. % and then heated to and maintained at 185° C. for a duration of 24 days. During the test, samples were taken to monitor the evolution of the pH.

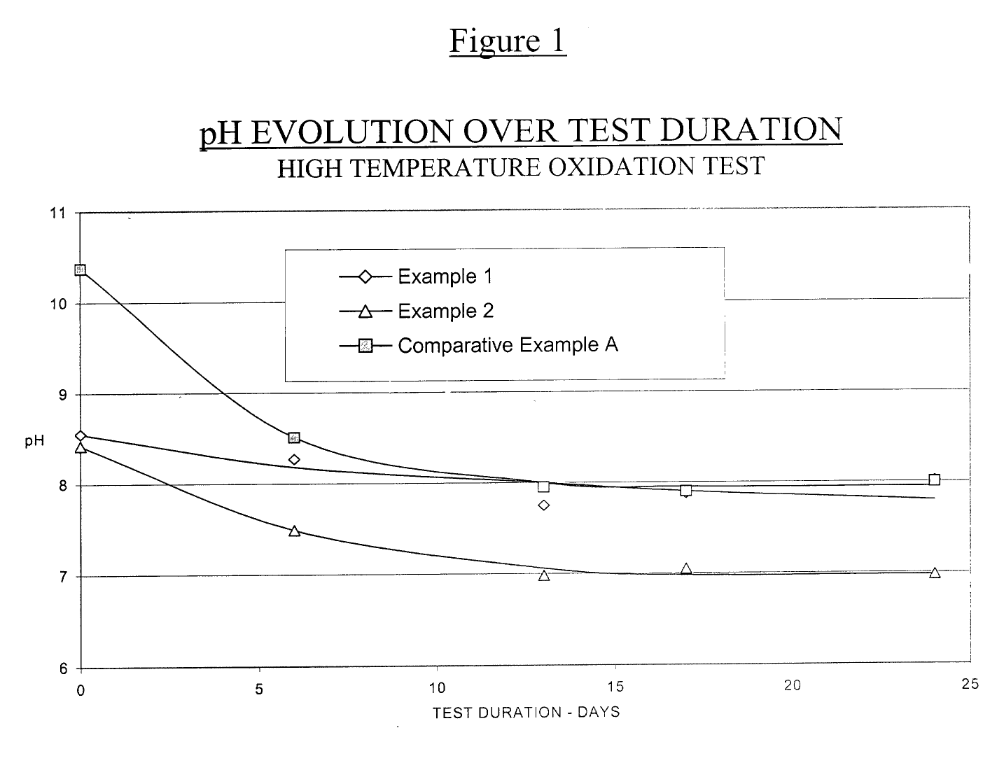

FIG. 1 depicts pH changes over the course of 24 days for the tested coolants. The change in pH is minimal for Example 1, containing imidazole next to carboxylate inhibitors, moderate for Example 2 with only carboxylate inhibitors, and high for the Comparative Example containing conventional inhibitors. This is already a first indication of the influence of the inhibitor package on the effect of high temperature exposure on the stability of the glycol coolant solution. The effect of the carboxylate inhibitor is further illustrated by the respective changes in reserve alkalinity of the tested examples.

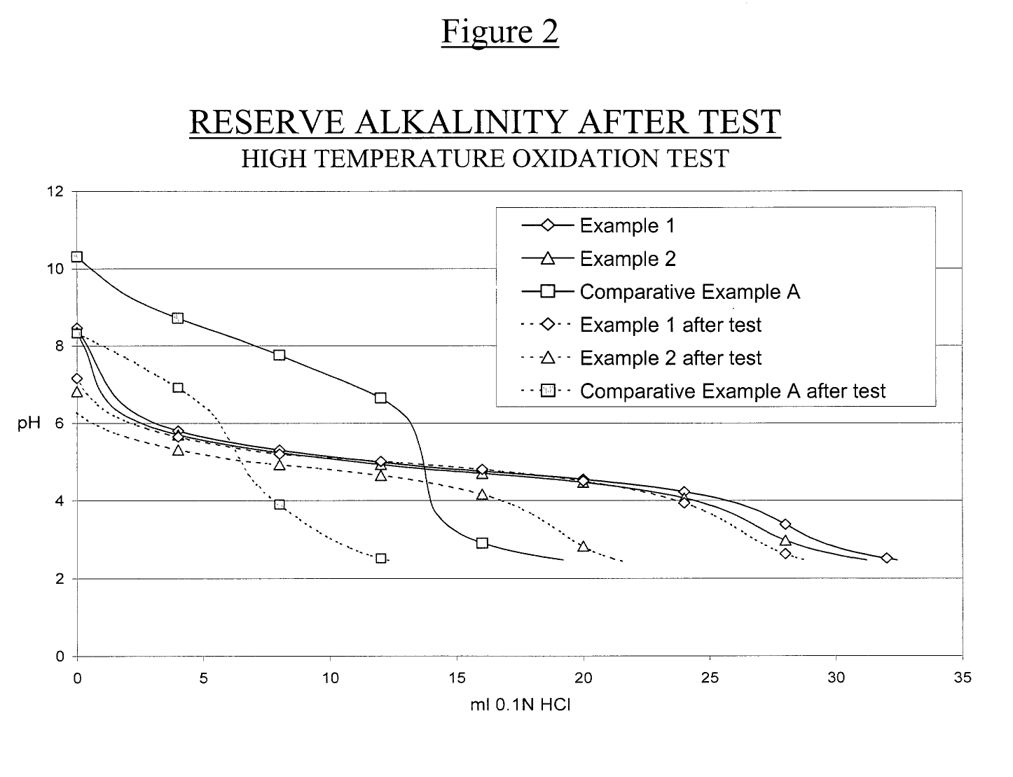

FIG. 2 shows acid titration curves of the coolants before and after test. This is an indication of the change in reserve alkalinity of the tested coolants. Again, Example 1 is showing the smallest change, while significant loss in reserve alkalinity is observed for the Comparative Example.

To verify the effect on the formation of glycol degradation products, the tested coolants were tested for glycolate, formate and oxalate content by electrophoresis. The technique employed does not differentiate between glycolate and acetate content. Results are shown in Table 1.

TABLE 1
GLYCOL DEGRADATION PRODUCTS
HIGH TEMPERATURE OXIDATION TEST - 24 DAYS
RESULTS OF ANALYSIS BY ELECTROPHORESIS

| | | | | | Glycolate + |
|---|---|---|---|---|---|
| | Formate | | Oxalate | | Acetate |
| Sample | (mg/l) | | (mg/l) | | (mg/l) |
| Example 1 | <10 | mg/l | <10 | mg/l | 430 mg/l |
| Example 2 | <10 | mg/l | <10 | mg/l | 320 mg/l |
| Comparative | 1400 | mg/l | 270 | mg/l | 750 mg/l |
| Example A | | | | | |

High levels of oxidation products are found for the Comparative Example. Particularly low values are found in oxalate and formate content for Examples 1 and 2.

In addition to oxidative degradation of glycol, metal corrosion properties of Examples 1, 2 and Comparative Example A before and after exposure to the high temperatures in this test were evaluated electrochemically by a cyclic polarization technique according to the procedures described in the U.S. Pat. Nos. 4,647,392 and 5,366,651. Protection of steel is shown as an example. Similar behavior was observed when evaluating protection of aluminum and the other metals used in engine cooling systems.

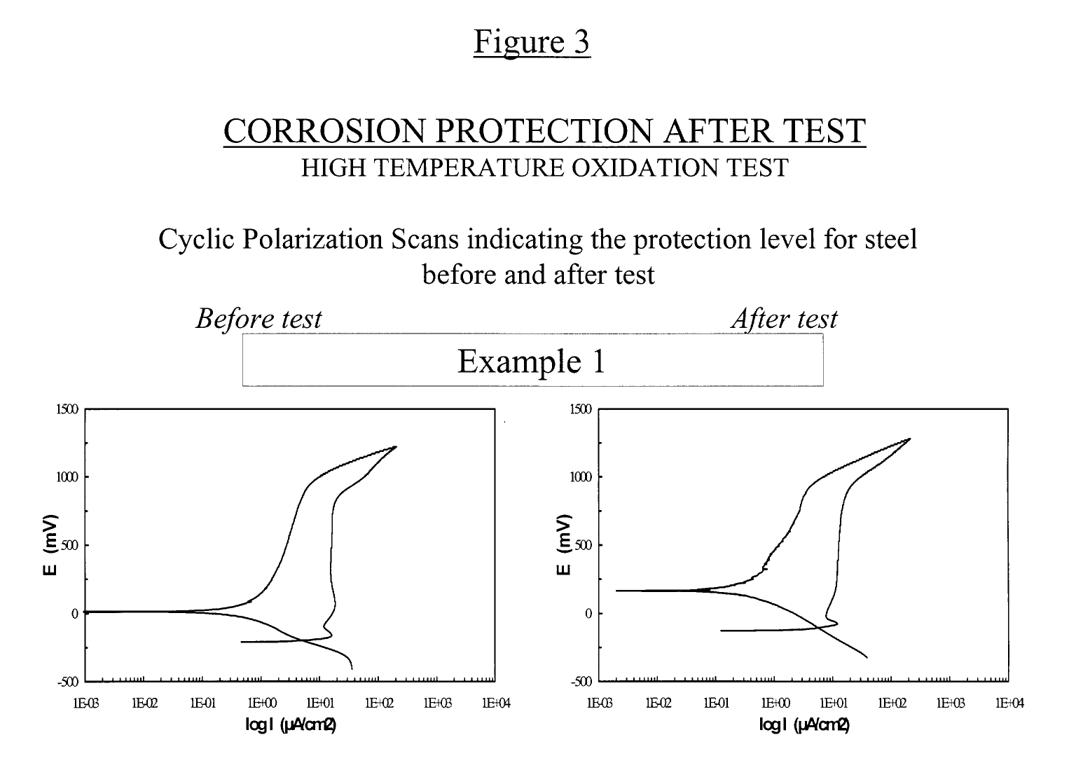

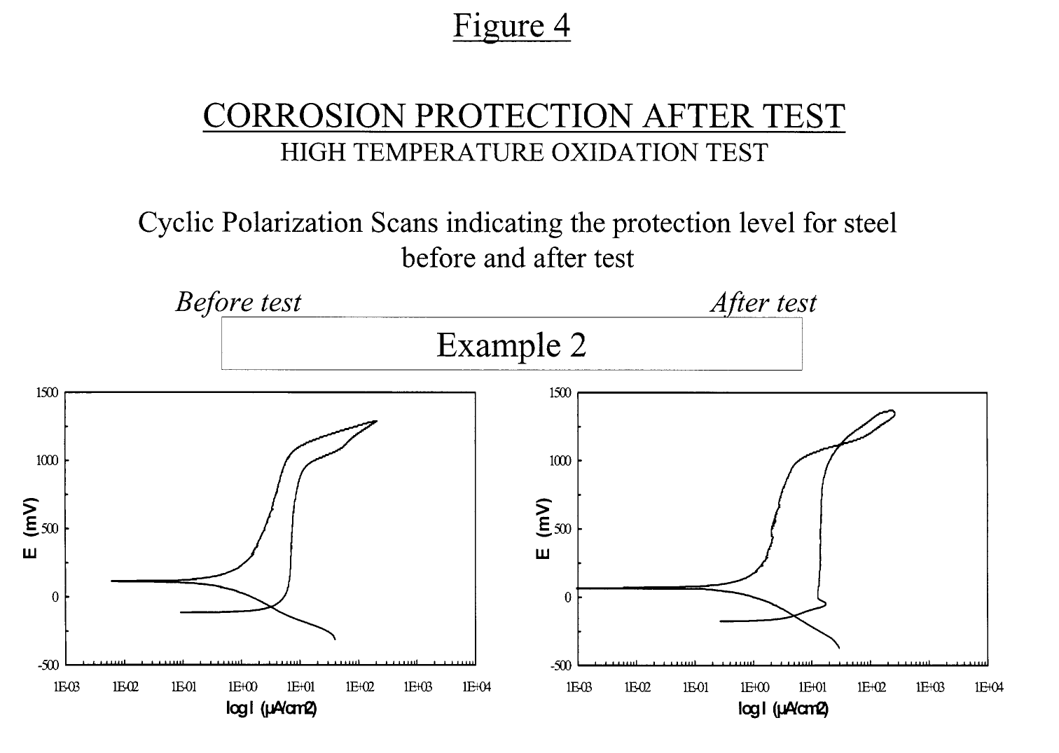

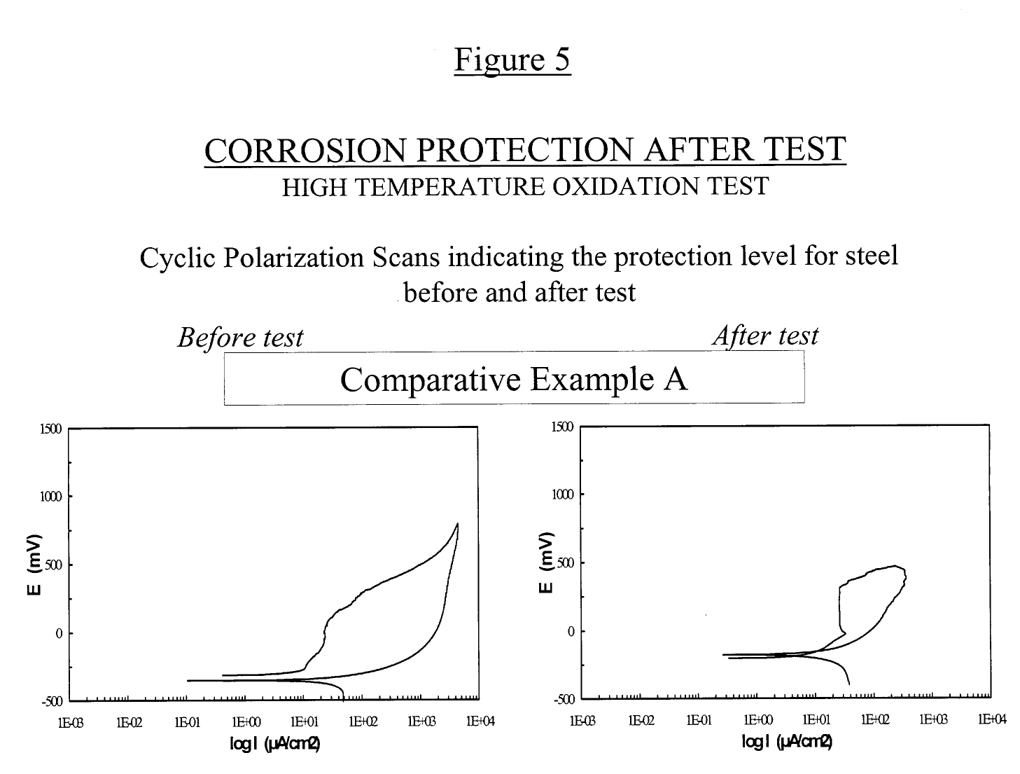

FIGS. 3 and 4 depict cyclic polarization curves before and after the high temperature oxidation test for Examples 1, 2 and Comparative Example A. The curves for Examples 1 and 2 (FIGS. 3 and 4) show no significant differences and verify high temperature oxidation resistance thereof. The polarization curves for the Comparative Example A (FIG. 5) show a decline in protective properties for steel after high temperature exposure.

To further illustrate the performance of the carboxylate corrosion inhibitor combinations of this invention in moderating high temperature oxidation reactions various coolant formulations were evaluated. The concentrated coolant fluids were diluted with water to 33-vol. % and then heated to and maintained at 185° C. for a duration of 12 days. After test, samples were analyzed by electrophoresis for the presence of glycol oxidation products.

### Example 3

A coolant concentrate containing a major amount of ethylene glycol, a combination of carboxylate corrosion inhibitors comprising 3.25% of 2-ethyl hexanoic acid and 0.25% sebacic acid, 0.04% of imidazole, 0.2% of tolyltriazole, 0.01% of denatonium benzoate (bittering agent) and sufficient NaOH to neutralize the formulation at a pH between 7.0 and 9.0.

### Example 4

A coolant concentrate containing a major amount of ethylene glycol, a combination of carboxylate corrosion inhibitors comprising 3.25% of 2-ethyl hexanoic acid and 0.25% sebacic acid, 0.2% of tolyltriazole and sufficient KOH to neutralize the formulation at a pH between 7.0 and 9.0.

### Example 5

A coolant concentrate containing a major amount of ethylene glycol, a combination of carboxylate corrosion inhibitors comprising 3.25% of 2-ethyl hexanoic acid and 0.25% sebacic acid, 0.2% of tolyltriazole, 0.28% sodium molybdate, 0.17% sodium nitrate and sufficient KOH to neutralize the formulation at a pH between 7.0 and 9.0.

### Example 6

A coolant concentrate containing a major amount of ethylene glycol, a combination of carboxylate corrosion inhibitors comprising 2.2% of 2-ethyl hexanoic acid and 1.2% sebacic acid, 0.1% of tolyltriazole, 0.2% sodium metasilicate, silicate stabilizer, 1.2% borate, 0.2 nitrate and sufficient KOH to neutralize the formulation at a pH between 7.0 and 9.0.

### Example 7

A coolant concentrate containing a major amount of ethylene glycol, a combination of carboxylate and conventional corrosion inhibitors comprising 0.5% of octanoic acid and 0.17% benzoic acid, 0.2% of tolyltriazole, 0.2% sodium metasilicate, silicate stabilizer, 1% borate, 0.2 nitrate and sufficient NaOH to neutralize the formulation at a pH between 7.0 and 9.0.

### Comparative Example B

A commercial coolant concentrate containing a major amount of ethylene glycol, a combination of conventional inhibitors comprising benzoate, borate, nitrate, nitrite, benzotriazole and silicate.

### Comparative Example C

A commercial coolant concentrate containing a major amount of ethylene glycol, a combination of conventional inhibitors comprising benzoate, borate, nitrate, nitrite, tolyltriazole and silicate.

To verify the effect on the formation of glycol degradation products, the tested coolants were tested for glycolate, oxalate and formate content by electrophoresis. Results are shown in Table 2.

TABLE 2
GLYCOL DEGRADATION PRODUCTS
HIGH TEMPERATURE OXIDATION TESTS - DAYS
RESULTS OF ANALYSIS BY ELECTROPHORESIS

| | | | | Glycolate + |
|---|---|---|---|---|
| | Formate | | Oxalate | acetate |
| Example | (mg/l) | | (mg/l) | (mg/l) |
| Example 1 | 28 | mg/l | <13 mg/l | 122 mg/l |
| Example 2 | <7 | mg/l | <13 mg/l | 105 mg/l |
| Example 3 | 15 | mg/l | <13 mg/l | 143 mg/l |
| Example 4 | 9 | mg/l | <13 mg/l | 254 mg/l |
| Example 5 | 94 | mg/l | <13 mg/l | 239 mg/l |
| Example 6 | 13 | mg/l | <13 mg/l | 167 mg/l |
| Example 7 | 25 | mg/l | <13 mg/l | 303 mg/l |
| Comparative | 263 | mg/l | <13 mg/l | 2537 mg/l |
| Example B | | | | |
| Comparative | 175 | mg/l | 23 mg/l | 1595 mg/l |
| Example C | | | | |

High levels of oxidation products are found for Comparative Example B and C. The total amount of oxidation products is low for Examples 1 to 7. It is thus observed that the Examples containing an aliphatic monocarboxylate show a significantly reduced level of glycol oxidation compared to the Comparative Examples. Example 7 contains conventional corrosion inhibitors similar to the corrosion inhibitors in Comparative Examples B and C. The improved performance of Example 7 can be attributed to the presence of the aliphatic monocarboxylate (octanoate). The aromatic monocarboxylate (benzoate) contained in Example 7 and also in Comparative Example B and C, does not appear to contribute to improved glycol oxidation protection. The present invention as disclosed and described herein is not intended to be limited to the described embodiments and the terms and expressions employed herein are used a terms of description and not of limitation. By use of the descriptive terms and expressions herein there is no intention to exclude equivalents of the features described and those skilled in the art will readily recognize that various modifications are possible within the scope of the invention claimed.

What is claimed is:

1. A method of cooling an internal combustion engine comprising circulating in a cooling system of said engine, operating at a temperature of at least 140 degrees C., an effective amount of an engine coolant comprising a liquid alcohol freezing point depressant and a C₅ to C₁₆ carboxylic acid or salt thereof.

2. The method of claim 1 wherein the C₅ to C₁₆ carboxylic acid is either one or a mixture of a C₅ to C₁₆ monocarboxylic acid, a C₅ to C₁₆ dicarboxylic acid or the alkali metal, ammonium or amine salts thereof.

3. The method of claim 1 wherein the C₅ to C₁₆ carboxylic acid is aliphatic.

4. The method of claim 1 wherein the engine coolant further comprises an alkylbenzoic acid or the alkali metal, ammonium or amine salt thereof.

5. The method of claim 1 wherein the liquid alcohol freezing point depressant is a glycol ether.

6. The method of claim 5 wherein the glycol ether is selected from the group consisting of ethylene glycol, diethylene glycol, propylene glycol, dipropylene glycol and glycol monoethers selected from the group consisting of methyl, ethyl, propyl and butyl ethers of ethylene glycol, diethylene glycol, propylene glycol, and dipropylene glycol.

7. The method of claim 6 wherein the liquid alcohol freezing point depressant is selected from the group consisting of ethylene glycol and propylene glycol.

8. The method of claim 1 wherein the C₅ to C₁₆ monocarboxylic acid or the alkali metal, ammonium or amine salt of said acid is present in an amount from 0.001 to 15 weight percent.

9. The method of claim 8 wherein the C₅ to C₁₆ monocarboxylic acid or the alkali metal, ammonium or amine salt of said acid is present in an amount from 0.01 to 3.5 weight percent.

10. The method of claim 2 wherein the alkali metal salt is sodium or potassium

11. The method of claim 1 wherein the C₅ to C₁₆ aliphatic dicarboxylic acid or the alkali metal, ammonium or amine salt of said acid is present in an amount from 0.001 to 15 weight percent.

12. The method of claim 11 wherein the C₅ to C₁₆ dicarboxylic acid or the alkali metal, ammonium or amine salt of said acid is present in an amount from 0.01 to 3.5 weight percent.

13. The method of claim 1 wherein the engine coolant further comprises a triazole selected from the group consisting of hydrocarbonyl triazole, aromatic hydrocarbonyl triazole, alkyl substituted aromatic triazole, benzotriazole and tolyltriazole.

14. The method of claim 13 wherein the selected triazole is present in an amount ranging from 0.0001 to 0.5 weight percent.

15. The method of claim 13 wherein the selected triazole is present in an amount ranging from about 0.0001 to 0.3 weight percent.

16. The method of claim 1 wherein the engine coolant further comprises an imidazole present in an amount ranging from about 0.0005 to 5.0 weight percent.

17. The method of claim 16 wherein the imidazole is present in an amount ranging from 0.001 to 1 weight percent.

18. The method of claim 16 wherein the imidazole is alkyl or aryl substituted.

19. The method of claim 1 wherein the carboxylic acid or salt thereof is an aliphatic C₇ to C₁₂ monocarboxylic acid or the alkali metal, ammonium, or amine salt of said acid and is present in a concentration range of 0.1 to 2.5 weight percent.

20. The method of claim 19 wherein the C₇ to C₁₂ aliphatic monocarboxylic acid is selected from the group consisting of heptanoic acid, octanoic acid, nonanoic, decanoic acid, undecanoic acid, dodecanoic acid, 2-ethylhexanoic acid and neodecanoic acid.

21. The method of claim 19 wherein the C₇ to C₁₂ aliphatic monocarboxylic acid is octanoic acid or 2-ethylhexanoic acid.

22. The method of claim 1 wherein the carboxylic acid or salt thereof is a C₈ to C₁₂ dicarboxylic acid or the alkali metal, ammonium, or amine salt of said acid.

23. The method of claim 22 wherein the C₈ to C₁₂dicarboxylic acid is selected from the group consisting of suberic acid, azelaic acid, sebacic acid, undecanedioic acid, dodecanedioic acid, the diacid of dicyclopentadiene (DCPDDA), terephthalic and mixtures thereof.

24. The method of claim 23 wherein the C₈ to C₁₂dicarboxylic acid is sebacic acid.

25. The method of claim 1 wherein the engine coolant further comprises one or more corrosion inhibitors selected from the group consisting of alkali metal silicates, alkali metal benzoates, alkali metal nitrates, alkali metal nitrites, alkali metal molybdates, hydrocarbyl thiazoles, hydrocarbyl triazoles, hydrocarbyl thiazoles and sodium metasilicate pentahydrate.

26. The method of claim 25 wherein the selected corrosion inhibitors are present in a concentration range of about 0.001 to 5.0 weight percent.

27. The method of claim 25 wherein organosilane stabilizers are used in conjunction with sodium metasilicate pentahydrate.

28. The method of claim 1 wherein the engine coolant is diluted with an aqueous antifreeze coolant solution comprising 10 to 90 weight percent of water.

29. The method of claim 28 wherein the engine coolant is diluted with an aqueous antifreeze coolant solution comprising 25 to 50 percent by weight of water.

30. The method of claim 1 wherein at least one alkali metal hydroxide is added to the engine coolant to adjust pH range from about 6.5 to 9.5.

31. The method of claim 30 wherein at least one alkali metal hydroxide is added to the engine coolant to adjust the pH range from about 7.0 to 9.0.
